(19) United States
(12) Patent Application Publication
(10) Pub. No.: US 2014/0214593 A1
(43) Pub. Date: Jul. 31, 2014

(54) Custom Fitting Tools

(71) Applicant: David Craycraft, Santa Monica, CA (US)

(72) Inventor: David Craycraft, Santa Monica, CA (US)

(21) Appl. No.: 14/167,563

(22) Filed: Jan. 29, 2014

Related U.S. Application Data
(60) Provisional application No. 61/758,487, filed on Jan. 30, 2013.

(51) Int. Cl. G06Q 30/06

(52) U.S. Cl. CPC G06Q 30/0631
USPC 705/26.7

(57) ABSTRACT

Methods, systems, and devices, including computer program products, for custom fitting services are disclosed. Relevant expert rules for product selection and fit are applied to a customer's unique physical characteristics as well as skill level in an applicable sport. A disclosed custom fitting tool is operable to show manufacturer photos or video assets of one or more products while a customer is trying on or comparing products in a retail store. Custom e-mail or text messages may be sent directly from the tool itself. The tool may also advantageously include a strike rate process, a personalized smart product recommendations process, and a codification process. The disclosed inventions advantageously increase sales, increase customer satisfaction, increase upsells, allow for more efficient use of a salesperson's and customer's time, and provide for other benefits.

### CROSS-REFERENCE TO RELATED APPLICATION

The present application claims benefit of and priority to U.S. Provisional Patent Application Ser. No. 61/758,487filed on Jan. 30, 2013 entitled “Custom Fitting Tools,” the entire contents of which are hereby incorporated by reference herein.

### BACKGROUND

The present disclosure relates generally to tools useful in the retail setting to increase sales and customer satisfaction.

“Make me feel important.” This axiom goes a long way in successfully working with others. It is also speaks volumes about customer service and the resultant generation of higher sales.

Today's world is moving closer and closer to a norm of impersonal service caused in part by buying goods over the Internet. Such commoditization need not be the answer. Brick and mortar stores still exist and they should do everything possible to utilize their inherent advantage of having the customer close at hand. With such proximity, a retail salesperson has the ability to provide personalized customer service. And when it comes to products that may benefit from custom fitting services, a retail salesperson should use appropriate tools to make the customer happy and in turn make the sale. However, few tools, if any, exist.

Accordingly, methods, systems, and devices, including computer program products, for custom fitting services are therefore desired.

### SUMMARY

One exemplary embodiment of the disclosed subject matter is a method including obtaining data about a customer's physical characteristics and skill level in a sport, obtaining product information about one or more products, identifying one or more expert rules about product selection for the one or more products, and applying the one or more expert rules to the customer data to select a product. The method may further comprise identifying one or more expert rules about product fit, and applying the one or more rules to the customer data to be able to advise how to custom fit the product. The method may also comprise encoding the operations on a computer readable medium operable to cause an electronic device to perform operations including sending e-mail or text messages directly from the electronic device to a customer. The method may also include showing one or more manufacturer photos or video assets of the one or more products to a customer while the customer is trying on or comparing the one or more products.

Another exemplary embodiment of the disclosed subject matter is an electronic device comprising one or more processors configured to perform operations. The operations may include obtaining data about a customer's physical characteristics and skill level in an applicable sport, obtaining product information about one or more products, identifying one or more expert rules about product fit for the one or more products, and applying the one or more expert rules to the customer data to fit a product. The one or more processors may be configured to perform operations further comprising identifying one or more expert rules about product selection, and applying the one or more rules to the customer data to be able to select a product. The one or more processors also may be configured to perform operations including sending e-mail or text messages directly from the electronic device to a customer, as well as show manufacturer photos or video assets to the customer to increase the likelihood of a sale.

A further exemplary embodiment of the disclosed subject matter is a computer readable program product, encoded on a computer readable medium, operable to cause an electronic device to perform operations including obtaining data about a customer's physical characteristics and skill level in an applicable sport, obtaining product information about one or more products, identifying one or more expert rules about product selection and fit for the one or more products, and applying the one or more expert rules to the customer data to select a product and advise how to fit a product. The product may advantageously be operable to cause the electronic device to perform operations further comprising sending e-mail or text messages directly from the electronic device to a customer. The product may also be operable to cause the electronic device to perform operations further comprising showing one or more manufacturer photos or video assets of the one or more products to a customer while the customer is trying on or comparing the one or more products.

Another exemplary embodiment of the disclosed subject matter is a system including one or more processors configured to perform operations comprising obtaining data about a customer's physical characteristics and skill level in an applicable sport, obtaining product information about one or more products, identifying one or more expert rules about product selection for the one or more products, and applying the one or more expert rules to the customer data to select a product. The one or more processors may be configured to perform operations further comprising identifying one or more expert rules about product fit, and applying the one or more rules to the customer data to be able to advise how to fit a product. The one or more processors may also be configured to perform operations further comprising sending e-mail or text messages directly from the electronic device to a customer. The one or more processors may further be configured to perform operations further comprising showing one or more manufacturer photos or video assets of the one or more products to a customer while the customer is trying on or comparing the one or more products.

Yet another embodiment of the disclosed subject matter is a system having one or more processors configured to perform a strike rate process to provide data about how often a specific item, a brand of item, or a category of item is chosen when it is actually considered for purchase.

A further embodiment of the disclosed subject matter is a system having one or more processors configured to perform a personalized smart product recommendations process that provides updated, real-time data concerning current product inventory and/or products previously purchased products by the customer.

Another embodiment of the disclosed subject matter is a system having one or more processors configured to perform a codification process to provide feedback data or a set of standards to an industry that previously had no such set of standards.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a block diagram of an electronic device having an example welcome screen representative of the inventions disclosed herein;

FIG. 2 is a flow diagram illustrating an example process for custom fitting services pertinent to the disclosed inventions;

FIG. 3A is a flow diagram illustrating an example process for collecting data pertinent to custom fitting products;

FIG. 3B is a flow diagram illustrating an example data hierarchy design pertinent to custom fitting products;

FIG. 3C is a flow diagram illustrating an example process for inputting data pertinent to custom fitting products;

FIG. 4 is a flow diagram illustrating an example process for collecting product data pertinent to custom fitting products;

FIG. 5 is a flow diagram illustrating an example fit process and modifications process pertinent to custom fitting products;

FIG. 6 is a flow diagram illustrating an example product options and recommendation process pertinent to custom fitting products;

FIG. 7 is a flow diagram illustrating an example process for utilizing video or photo assets pertinent to custom fitting products;

FIG. 8 is a flow diagram illustrating an example e-mail or text message process pertinent to custom fitting products;

FIG. 9 is a screenshot of an example screen pertinent to store information representative of the inventions disclosed herein;

FIG. 10 is a screenshot of an example screen pertinent to client data representative of the disclosed inventions;

FIG. 11 is a screenshot of another example screen pertinent to client data representative of the disclosed inventions;

FIG. 12 is a screenshot of an example screen of a fit process and modifications process, a products process, and video/photos assets process pertinent to custom fitting products;

FIG. 13 is a screenshot of an example screen of a products process and video/photos assets process pertinent to custom fitting products;

FIG. 14 is a screenshot of an example screen of a fit process wherein modifications have been made to a boot pertinent to custom fitting products;

FIG. 15 is a screenshot of an example screen of part of a sales documents process pertinent to custom fitting products;

FIG. 16 is a screenshot of an example screen of an e-mail or text message process pertinent to custom fitting products;

FIG. 17 is a flow diagram illustrating a strike rate process for custom fitting services pertinent to the disclosed inventions;

FIG. 18 is a screenshot of a how a personalized product recommendations screen my look;

FIG. 19 is a flow diagram illustrating a personalized smart product recommendations process for custom fitting services pertinent to the disclosed inventions; and

FIG. 20 is a flow diagram illustrating a codification process that creates a set of standards in industries lacking standards.

### DETAILED DESCRIPTION

A general problem in the field of retail sales is a lack of a tool that increases customer interaction, customization of products, and engagement in the sales process. A general solution is a sales tool helpful to address each customer's uniqueness as well as provide custom fitting solutions.

A technical problem in the field of retail sales is how best to identify products that may be appropriate for each customer and then custom fit those products with or without any advice about how to do so. A technical solution implementing the spirit of the disclosed inventions is a custom fitting tool capable of providing a selection of appropriate products for each customer and optionally advising how best to modify a select product to provide a custom fit.

Potential benefits of the general and technical solutions provided by the disclosed subject matter include increased customer interaction in the sales process (including the capture of customer data), enhanced product recommendation and selection based on unique physical and other attributes of the customer, increased customer satisfaction, increased upsells (including the ability to have a customer enter one store and purchase, rent, or pick up products in another store), and more efficient use of a salesperson's and customer's time. Additional benefits also include a custom fitting tool for specific products that addresses unique customer data at a specific product level.

Potential benefits also include a custom interface wherein one or more e-mail or text messages may be sent directly from the application to the consumer. Additional benefits include a prescriptive fitting tool that uses relevant expert rules for product selection and fit that are applied to a customer's unique physical characteristics as well as skill level in an applicable sport. Other benefits include a custom fitting tool that is operable to show manufacturer photos or video assets of one or more products while a customer is trying on or comparing products in a retail store.

Empirical data of usage of one or more of the disclosed embodiments reveals that (1) customer conversion rate increases by not less than 10% at time of sale; (2) customer willingness to provide unique, user-identifiable data is in excess of 50%; (3) customer response rates to e-mail or text messaging increases additional sales by 10%; and (4) customer experience in the fitting process is enhanced by customer interaction with the disclosed electronic device and the salesperson to create a perceived subject matter expertise in the sales staff.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

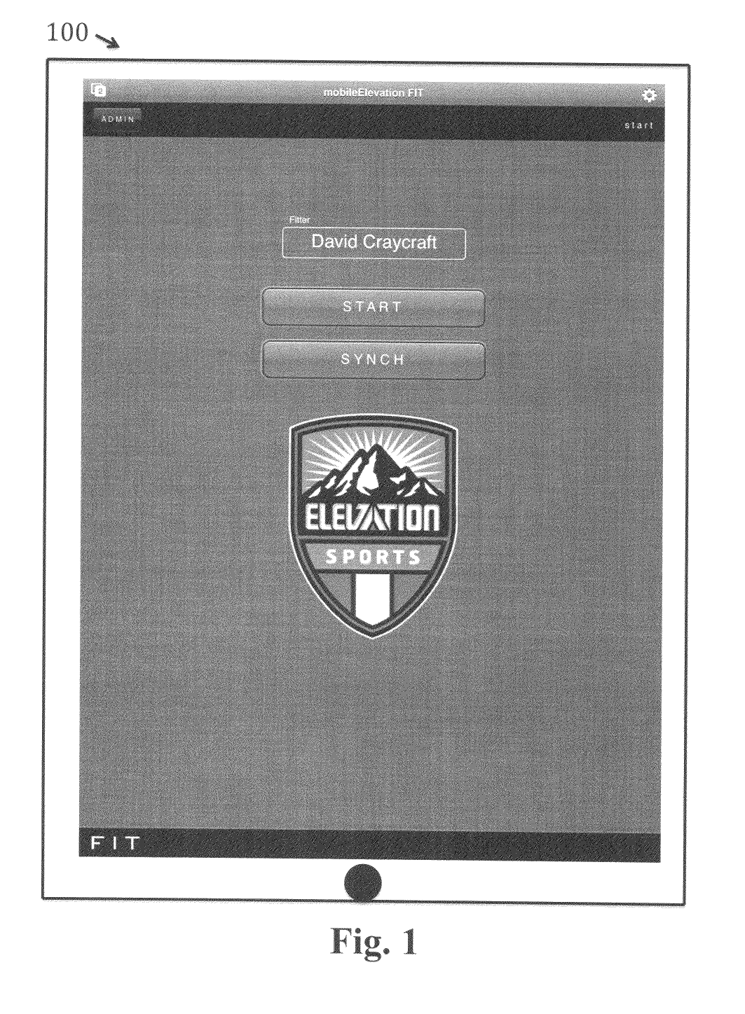

FIG. 1 is a block diagram of an electronic device 100 having an example welcome screen representative of the inventions disclosed herein. Device 100 can be, for example, a tablet computer, laptop, computer, handheld and/or mobile electronic digital device, including but not limited to a personal digital assistant, a cellular telephone, a network appliance, a camera, a smart phone, an enhanced general packet radio service mobile phone, a media player, an e-mail device, a game console, or other electronic device or a combination of any two or more of these data processing devices or other data processing services.

Device 100 may include a memory interface, one for more data processors, image processors and or central processing units, and peripherals interface. The memory interface, the one or more processors, and/or the peripherals interface may be separate components or integrated in one or more integrated circuits. The various components in the device 100 may be coupled by one or more communication buses or signal lines as is known in the art.

A computer program product, encoded on a computer readable medium, is operable to cause device 100 to perform operations relevant to custom fitting products. A computer readable medium may be any device or medium that can store code and/or data for use by a computer system. Such a device or medium includes but is not limited to a memory interface, magnetic or optical storage devices such as disk drives, magnetic tape, compact disc, digital video disc, and computer instruction signals embodied in a transmission medium (with or without a carrier wave upon which the signals are modulated). For example, the transmission medium may include a communications network, such as the Internet.

The welcome screen seen in FIG. 1 is merely exemplary in that other welcome or home screens may be employed at the start of the disclosed software application operable to help perform custom fitting services to increase sales and customer satisfaction.

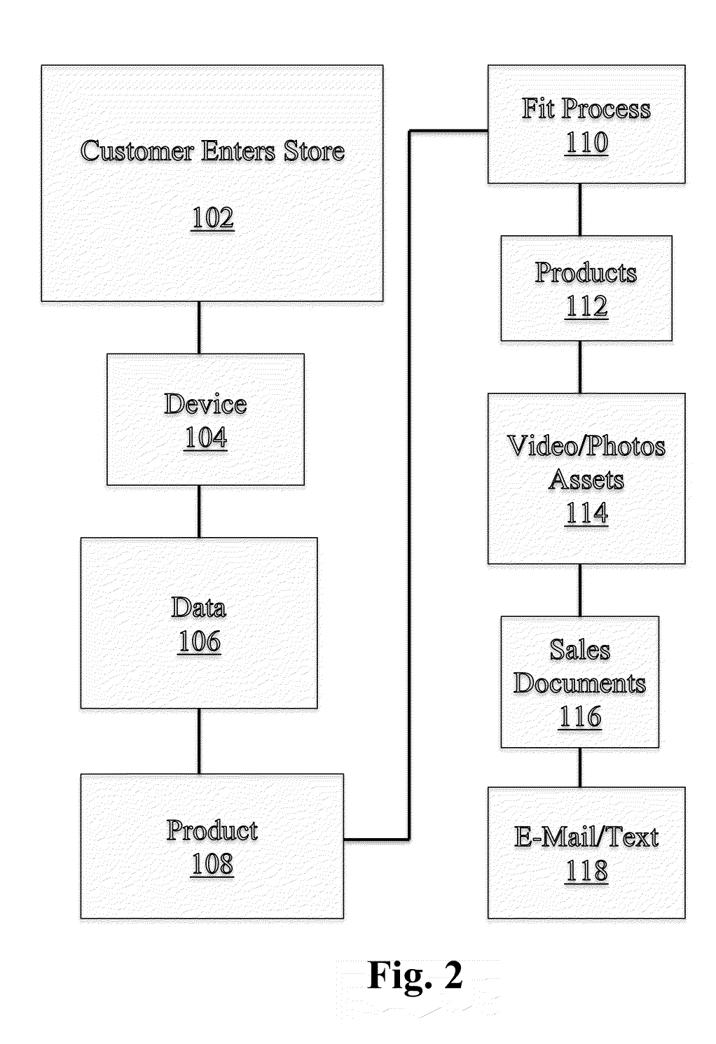

FIG. 2 is a high-level flow diagram illustrating an example process for custom fitting products pertinent to the disclosed inventions. As the disclosed inventions are particularly suited for use in a retail setting, the high-level flow diagram begins with that setting in mind and particularly with a customer entering a store, as seen in block 102. A retail salesperson then initiates personalized customer services using a tool, and particularly a device configured to perform custom fitting operations and related services as disclosed herein, such as device 100 seen in FIG. 1, as represented by block 104 in FIG. 2.

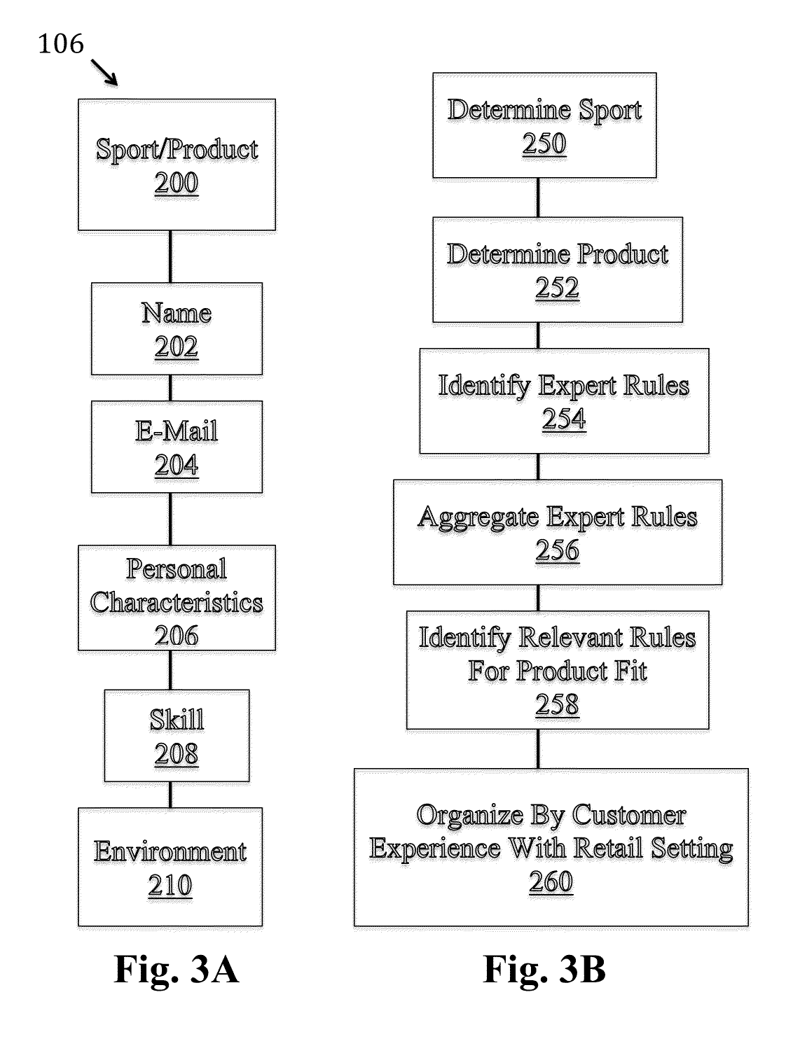

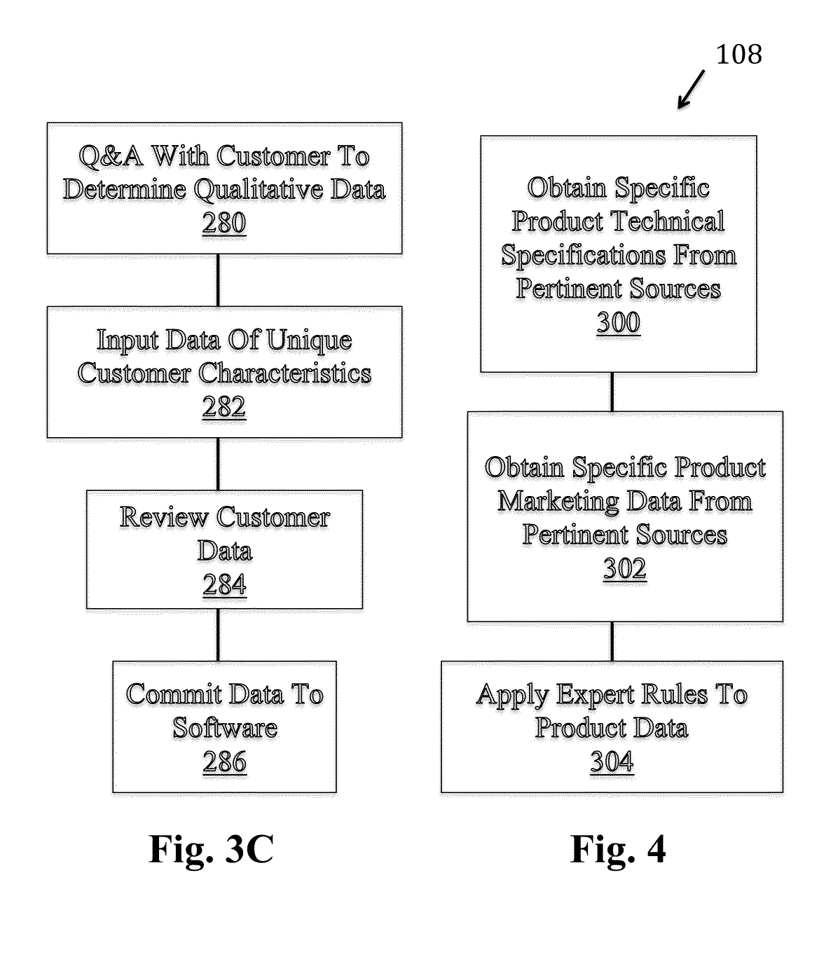

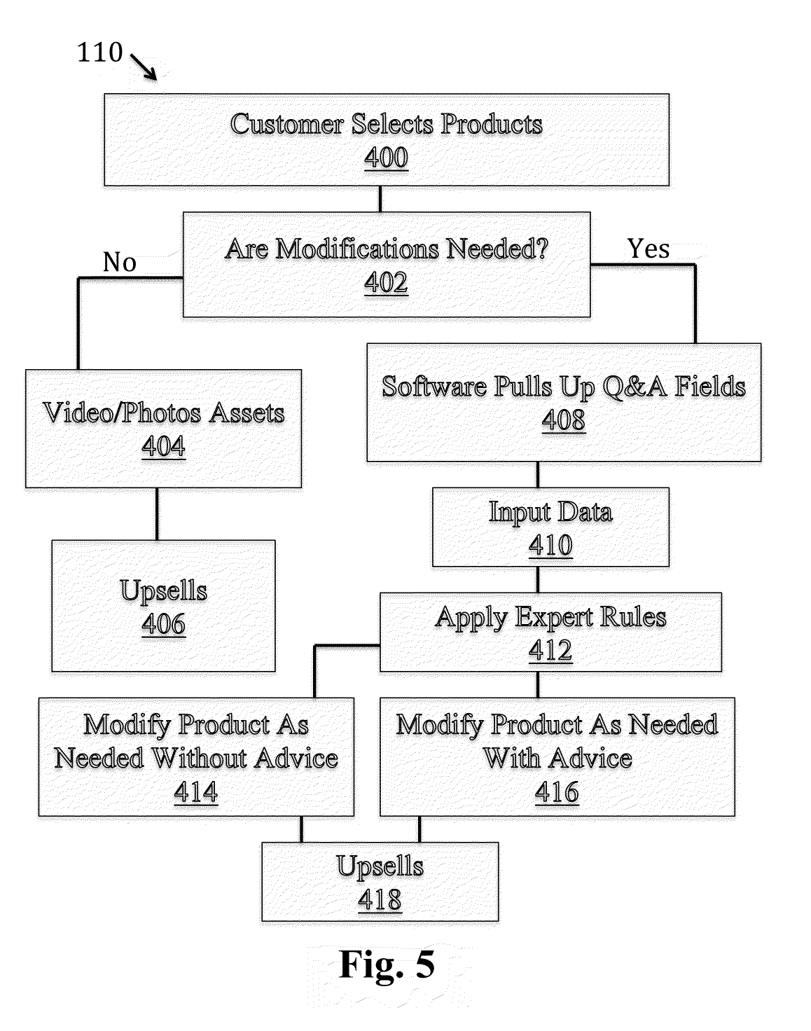

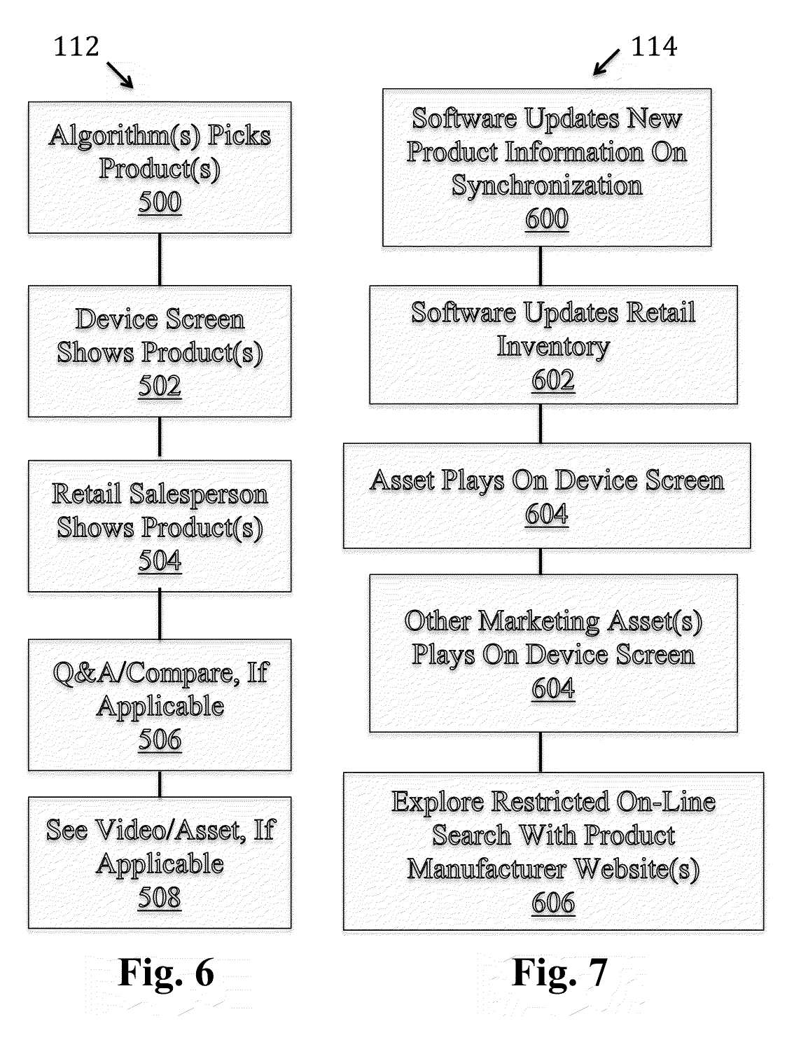

Data, which may be input or already have been inputted into device 100, or a combination thereof, then takes place as illustrated in block 106. Product information comes next followed by a fit process, and then product options and recommendations, as represented by blocks 108, 110, and 112, respectively. To help make the sale, the customer may be shown one or more videos, photos, or similar assets on the device 100, as seen in block 114. Sales documents, as seen in block 116, followed by e-mail or text messages per block 118, preferably come next in the example overview of the process. Exemplary functionality of the overview process of FIG. 2's blocks 106 through 118 may be seen in FIGS. 3A through FIG. 8. As can be seen in these figures, functionality disclosed in any block 106 through 118 of FIG. 2 may be duplicative or overlapping of another. For example, block 112's exemplary functionality may be seen in FIG. 6, wherein blocks 500 and 502 of FIG. 6 may be followed by blocks 400 and 402 of FIG. 5, which details exemplary functionality of block 110. By way of further example, block 500 of FIG. 6 may be followed by blocks 600, 602, and 604 of FIG. 7 and then followed by blocks 400 through 418 of FIG. 5; or any logical combination thereof.

Turning in detail to data block 106, FIG. 3A is a flow diagram illustrating an example process for collecting data pertinent to custom fitting products. The first step preferably involves identifying the sport or product of interest, per block 200. The next steps may include obtaining the customer's name, e-mail, personal characteristics, skill, and proposed environment, as represented by blocks 202, 204, 206, 208, and 210, respectively.

FIG. 3B is a flow diagram illustrating an example data hierarchy design pertinent to custom fitting products. As seen in FIG. 3B, the design may include determining the sport 250, determining the applicable product 252, and identifying expert rules 254. Once identified, the expert rules may be aggregated 256. Rules relevant for the applicable product fit may then be identified per block 258. The relevant rules may then be organized by customer experience within the retail setting as represented by block 260.

FIG. 3C is a flow diagram illustrating an example process for inputting data pertinent to custom fitting products. The first step 280 may include conducting a question and answer session with the customer to determine qualitative data. Such unique customer characteristics may then be input into the device, such as device 100, as per block 282. Next, the salesperson should review that customer data as seen in block 284, and commit that data to the software, i.e., save the data, as represented in block 286.

Turning in detail to block 108 illustrated in FIG. 2, FIG. 4 is a flow diagram illustrating an example process for collecting product data pertinent to custom fitting products. As seen in FIG. 4, the process may begin with obtaining specific product technical specifications from pertinent sources per block 300. Such sources may include manufacturer websites, manufacturer product sheets, retail inventory management system, or the like. Next, per block 302, the process may include obtaining specific product marketing data from pertinent sources per block 302. Such sources may include manufacturer websites, manufacturer product sheets, retail inventory management system, or the like. With this product data in hand, the process may conclude with applying expert rules to this data, per block 304.

Turning in detail to block 110 illustrated in FIG. 2, FIG. 5 is a flow diagram illustrating an example fit process and modifications process pertinent to custom fitting products. Such a fit process may begin with step 400 wherein the customer selects the desired product(s). The process may then ask whether modifications are needed, per block 402. If modifications are not needed, then video and/or photo assets may be shown to the customer as illustrated in block 404 for upsells 406. If modifications are needed, then the software disclosed herein may pull up question and answer fields, per block 408. Next, data is inputted (block 106) with expert rules being applied to that data per block 412. Thereafter, the salesperson may modify the product as needed without any advice provided by the disclosed software, per block 414, or alternatively, modify the product as needed based on advice provided by the disclosed software, per block 416. Upsells 418 may then take place after block 414 or block 416.

Turning in detail to block 112 illustrated in FIG. 2, FIG. 6 is a flow diagram illustrating an example product options and recommendation process pertinent to custom fitting products. As seen in FIG. 6, the process may involve the first step 500 wherein one or more algorithms in the disclosed software picks one or more products for the customer. Next, the device, such as device 100, may show one or more of these products on the device screen, as represented by block 502. The retail salesperson preferably next obtains the actual product to show to the customer per block 504. The customer and/or salesperson may then engage in a question and answer session or otherwise compare certain products, if applicable, as illustrated in block 506. To increase chances of making the sale, the retail salesperson then may show one or more videos, photos, or similar assets of the product(s) to the customer, per block 508.

Turning in detail to block 114 illustrated in FIG. 2, FIG. 7 is a flow diagram illustrating an example process for utilizing video or photo assets pertinent to custom fitting products. Such a process may include having a step 600 wherein the disclosed software updates new product information on synchronization initiated by the salesperson or the customer. The software then updates the retail store's inventory per block 602. A manufacturer video may then be played and/or manufacturer photo may be shown on the device screen as represented by block 604. Other marketing assets may then be played or shown per block 604. The customer may then optionally be permitted to conduct one or more restricted on-line searches with a product manufacturer's websites(s), as represented by block 606.

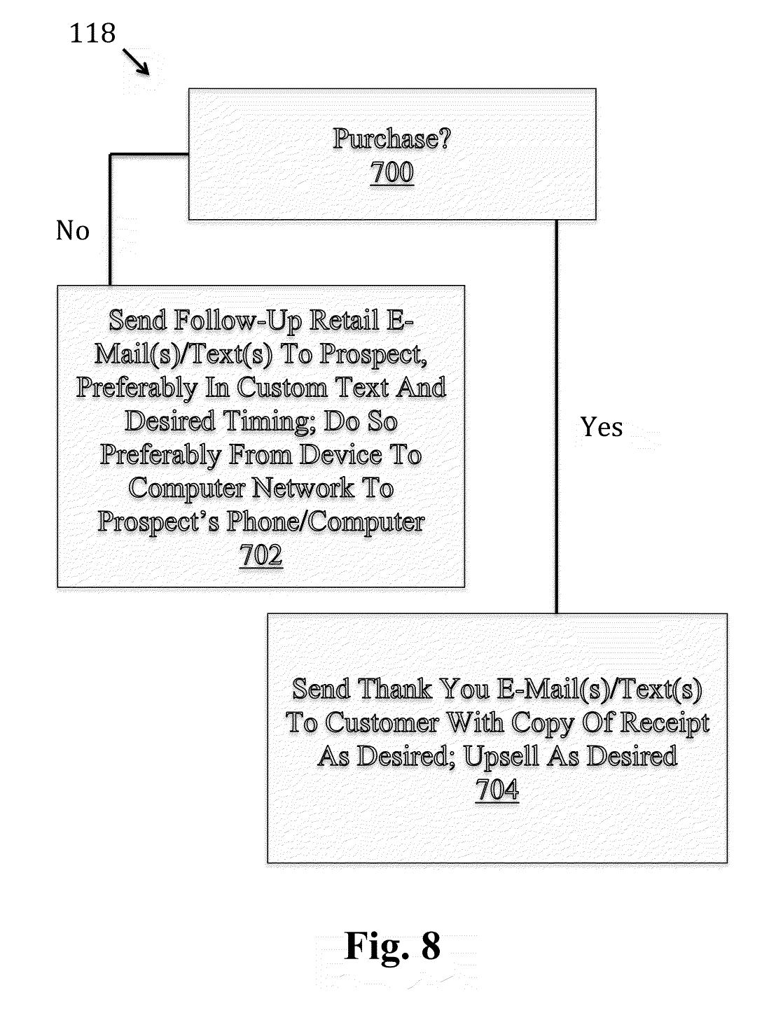

FIG. 8 is a flow diagram illustrating an example e-mail or text message process pertinent to custom fitting products, such as the e-mail or text message block 118 seen in FIG. 2. Turning in detail to FIG. 8, the process may begin by asking whether a purchase has been made as seen in block 700. If a purchase has not been made, then the disclosed software may be used to send a follow-up e-mail or text to the prospect as per block 702. The disclosed software preferably does so by using custom text and optionally within a desired time. For example, the software may be set up to send a follow-up text one week after the prospect left the store without a purchase. Advantageously, one merely need the disclosed software to do follow-up messages.

To elaborate, the salesperson or the like may write the desired e-mail or text inside of the application operable on the device. The desired e-mail or text is then sent to a computer and/or network, which then forwards to the prospect's phone and/or computer. If a purchase has been made, then the disclosed software may be used to send a thank you e-mail or text or the like to the customer with or without a soft copy of the receipt, as illustrated by block 704. The disclosed software may also optionally be used to make upsells as desired per block 704.

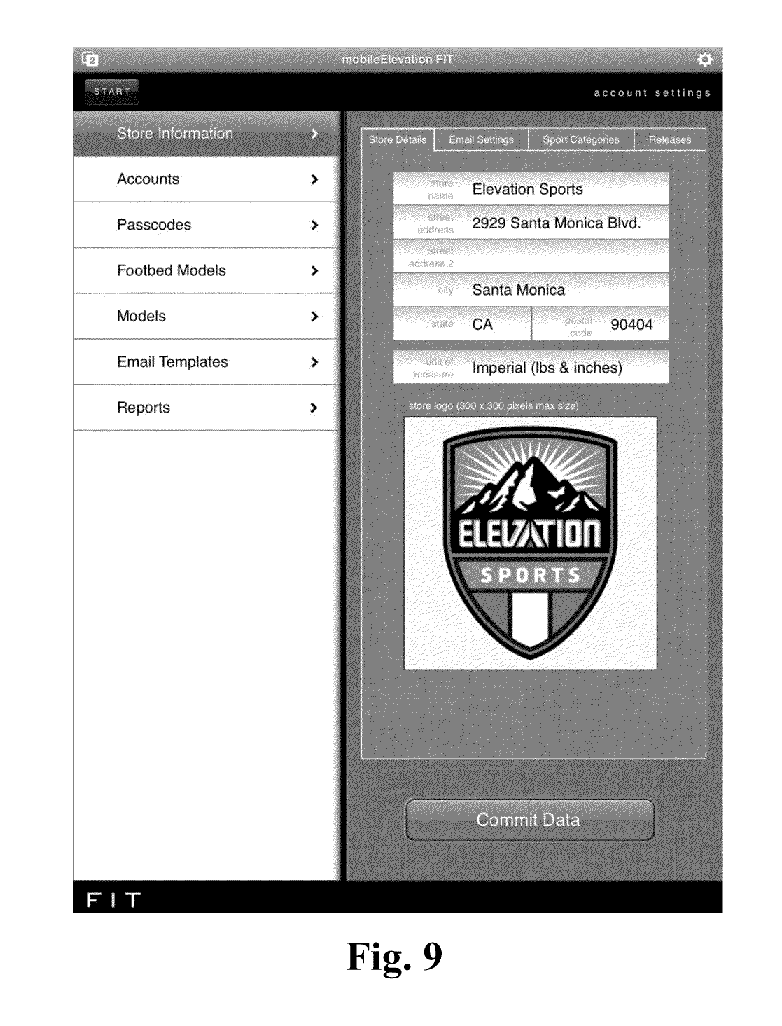

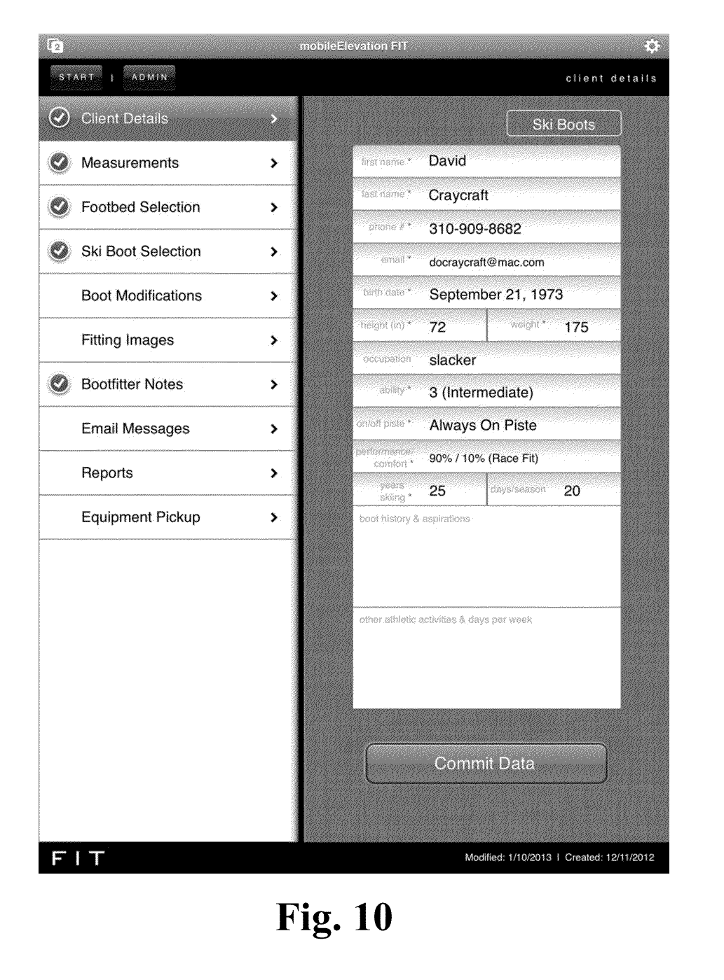

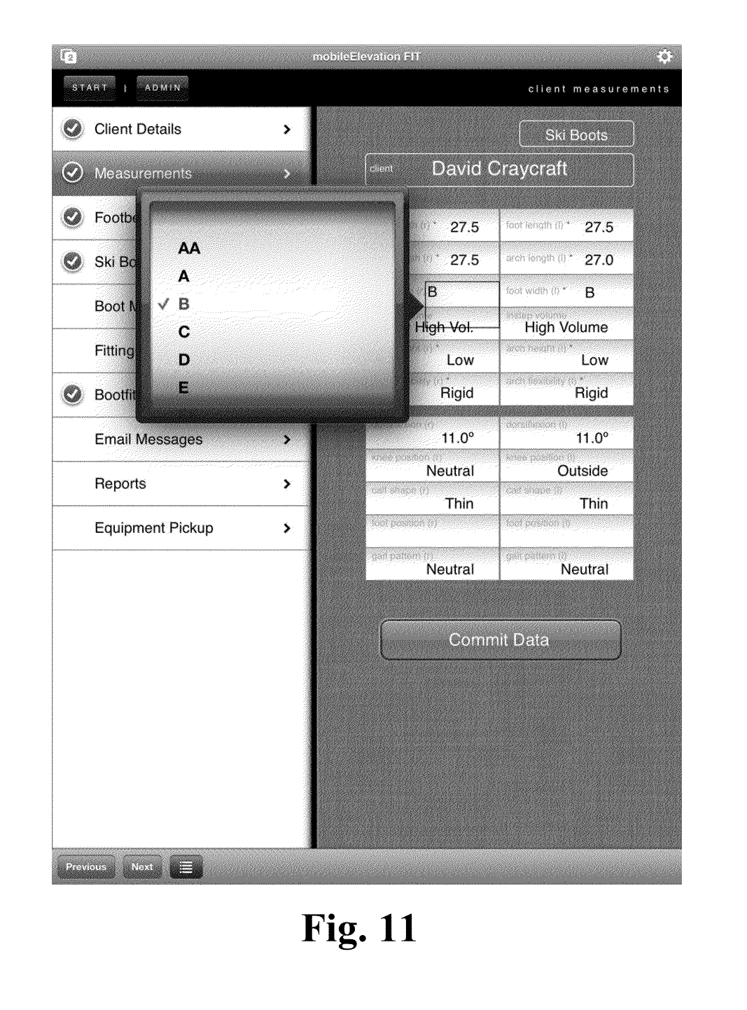

FIG. 9 is a screenshot of an example screen pertinent to store information representative of the inventions disclosed herein. Such a screen may include the store's name, address, and desired unit of measurement. FIG. 10 is a screenshot of an example screen pertinent to client data representative of the disclosed inventions. The client data may include the customer's name, e-mail, personal characteristics, skill, and proposed environment, as discussed above in the context of block 106 illustrated in FIG. 2.

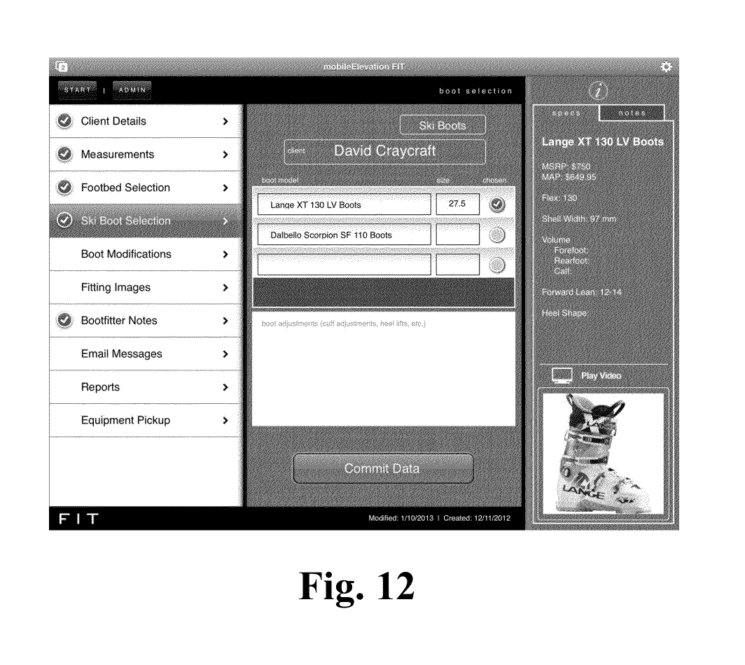

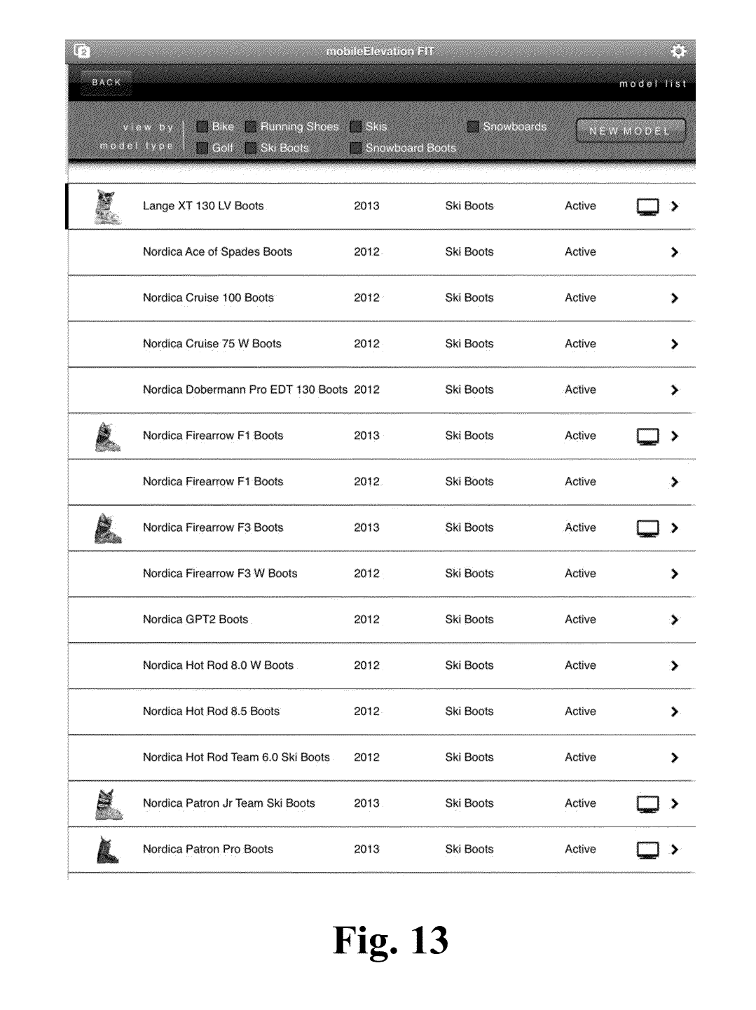

FIG. 11 is a screenshot of another example screen pertinent to client data representative of the disclosed inventions, as discussed above in the context of representative block 106 illustrated in FIG. 2. FIG. 12 is a screenshot of an example screen of a fit process and modifications process, a products process, and video/photos assets process pertinent to custom fitting products, as discussed above in the context of representative blocks 110, 112, 114 illustrated in FIG. 2.

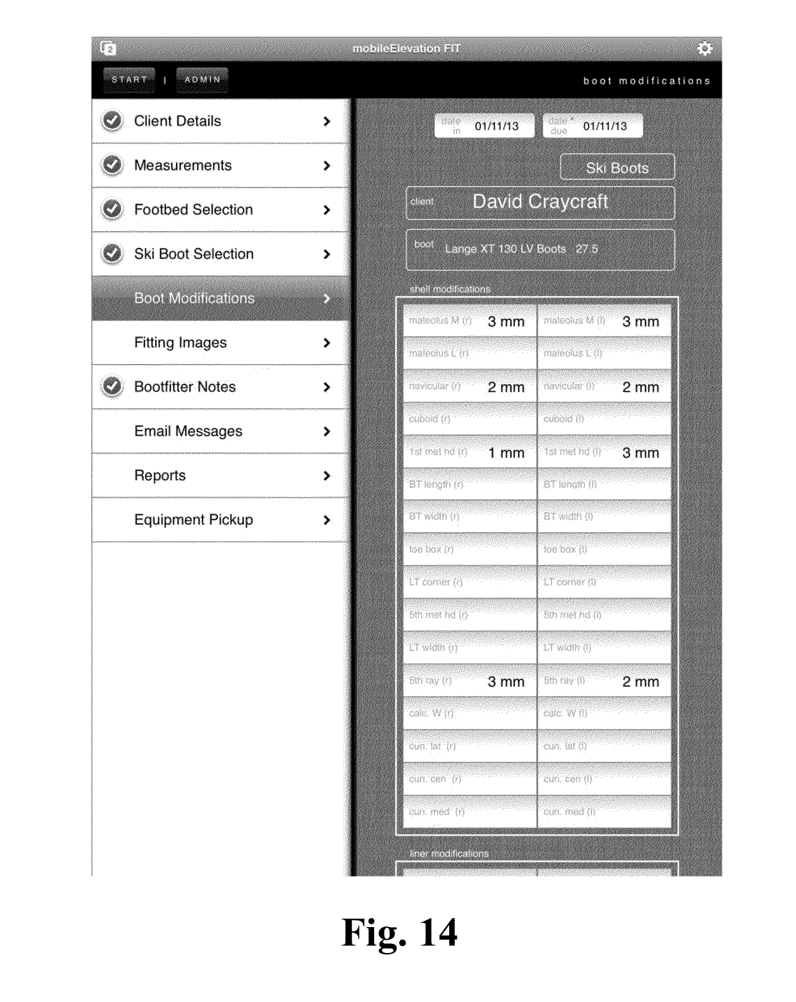

FIG. 13 is a screenshot of an example screen of a products process and video/photos assets process pertinent to custom fitting products, as discussed above in the context of representative blocks 112, 114 illustrated in FIG. 2. FIG. 14 is a screenshot of an example screen of a fit process wherein modifications have been made to a boot pertinent to custom fitting products, as discussed above in the context of representative block 110 illustrated in FIG. 2.

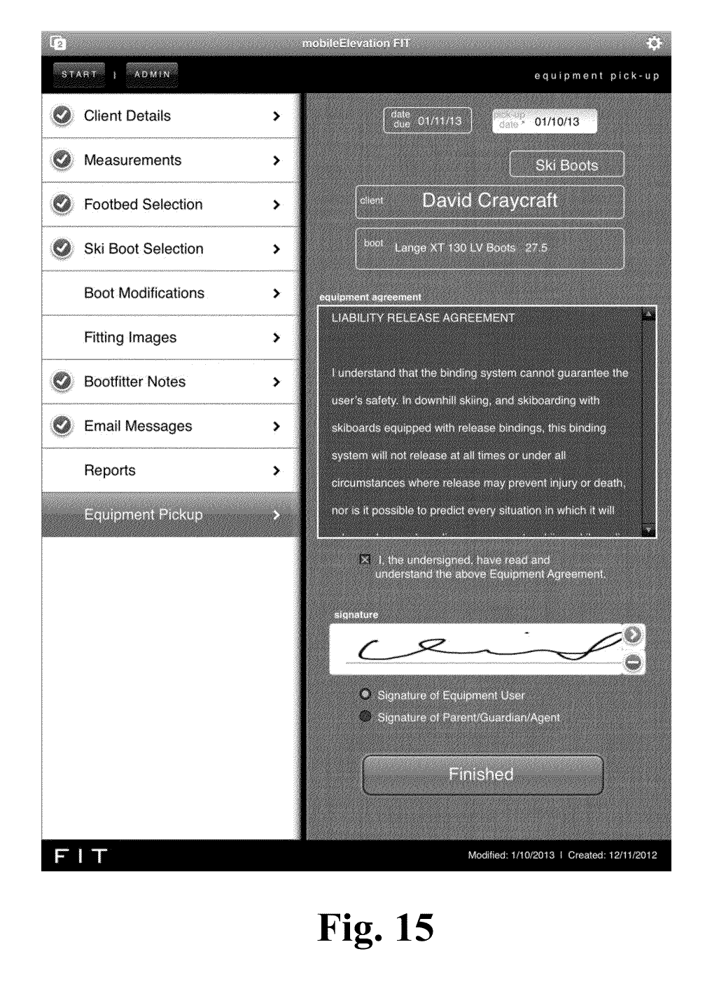

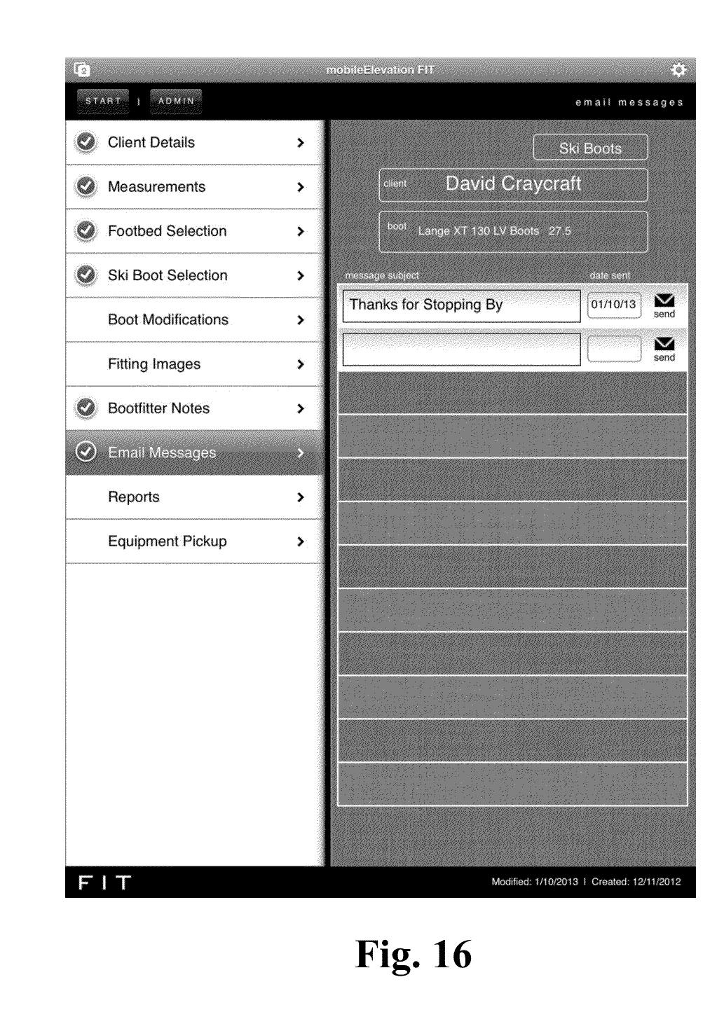

FIG. 15 is a screenshot of an example screen of part of a sales documents process, such as sales documents block 116 in FIG. 2, pertinent to custom fitting products. FIG. 16 is a screenshot of an example screen of an e-mail or text message process pertinent to custom fitting products, as discussed above in the context of representative block 118 illustrated in FIG. 2.

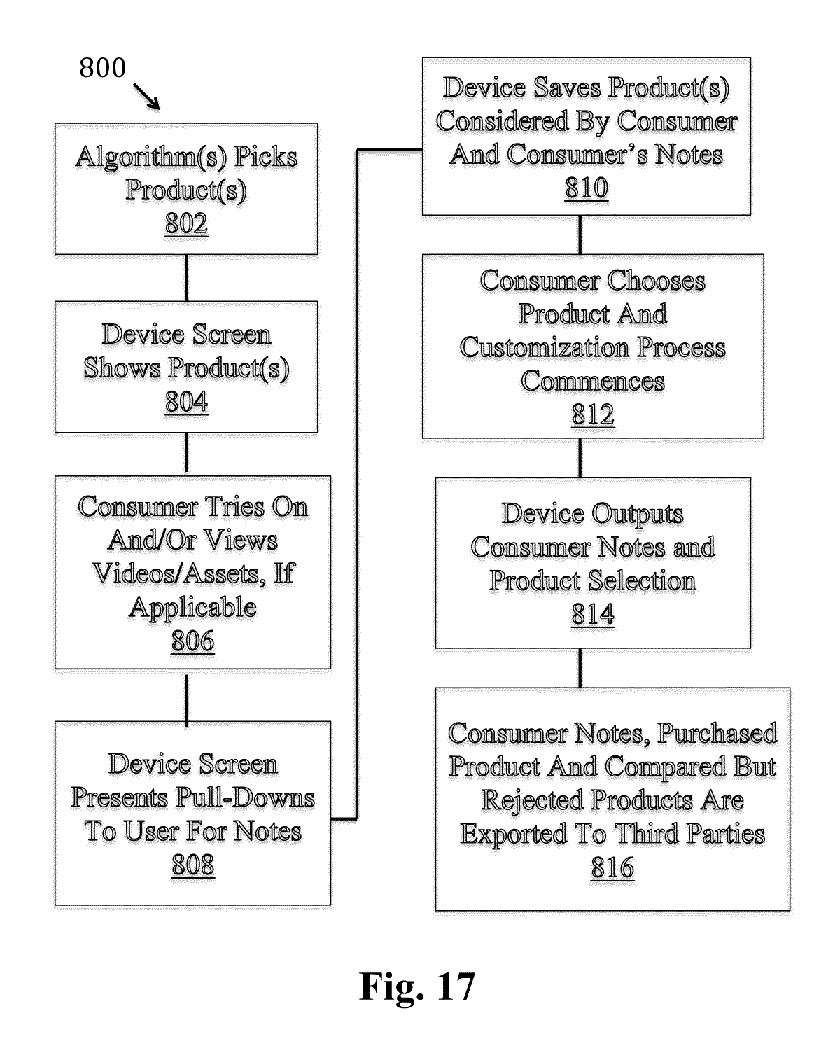

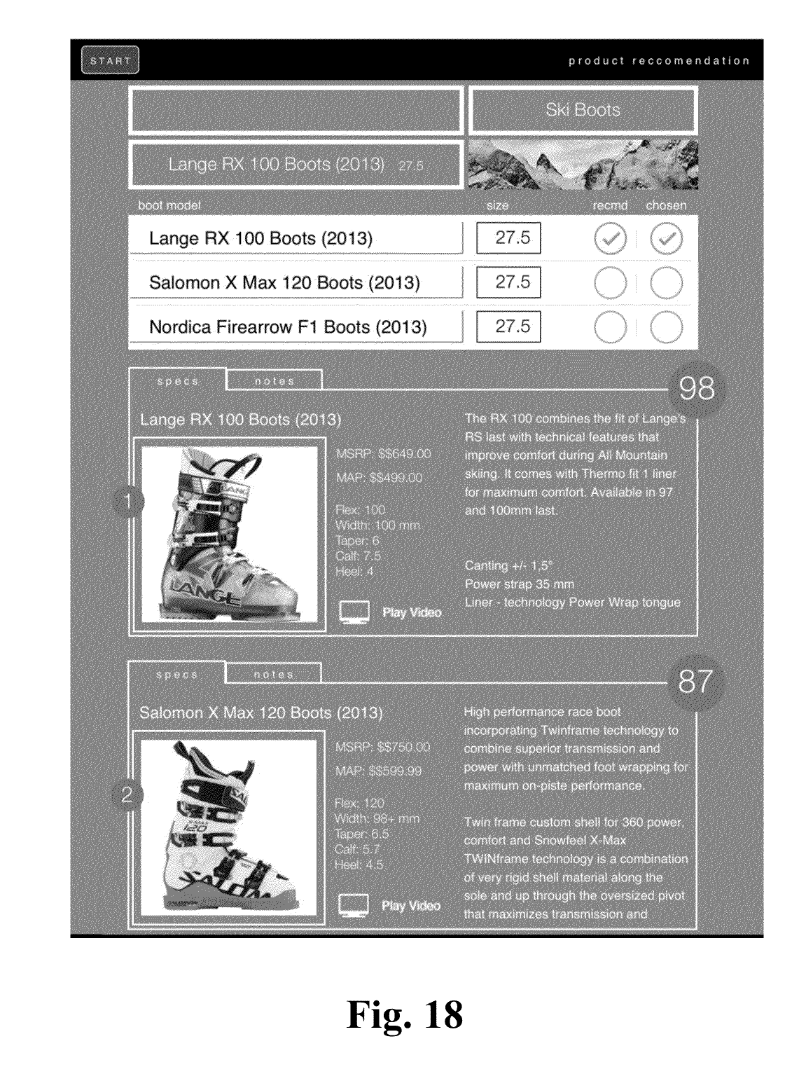

FIG. 17 is a flow diagram illustrating another advantageous aspect of the disclosed invention coined “strike rate.” Strike rate refers to how often a specific item, a brand of item, or a category of item is chosen when it is actually considered for purchase. Turning in detail to FIG. 17, the strike rate process 800 may begin with one or more algorithms picking or making product recommendations, preferably by model number, stock keeping unit (“SKU”), or what is in inventory, as seen in block 802. Next, the device screen may show one or more product recommendations to the user, as seen in block 804. Block 806 illustrates that the consumer may then try on and/or view video and/or photo assets pertinent to the products. The device screen then may be given to the consumer, via block 808, wherein the screen may present pull-downs to the consumer for notes and/or comments on the products tested and/or viewed. FIG. 18 is a screenshot of a how such a personalized product recommendations screen my look. Returning again to FIG. 17, the products considered and/or viewed, along with any consumer notes, which are preferably tied into the individual consumer's records, are then saved in the device, per block 810. Once the consumer has chosen a product, as seen in block 812, the disclosed invention then advantageously permits that product to be customized and/or modified, as needed, with or without advice provided by the device, as discussed above particularly with regard to FIG. 5. Next, as seen in block 814, the device may optionally output, such as via printing or e-mail, consumer notes and/or product selection. The device may optionally permit consumer notes, purchased product and compared but rejected products information to be exported to third parties, such as product manufacturers and retailers, as seen in block 816. Such information may take the form of one or more charts, such as that illustrated below.

Brands

| | | TRIED | | |
|---|---|---|---|---|
| BRAND | UNITS SOLD | ON | STRIKE RATE | % OF SALES |
| Nike | 16 | 24 | 62.6% | 48.4% |
| Adidas | 3 | 6 | 60.0% | 9.7% |
| New Balance | 6 | 14 | 35.7% | 16.1% |
| Saucony | 4 | 30 | 13.3% | 12.9% |
| Reebok | 4 | 10 | 40.0% | 12.9% |

As can be seen above, the strike rate information in this chart quickly reveals that Nike shoes are chosen for purchase 62.5% of the time that the brand's products are tried on, whereas Saucony shoes are chosen for purchase 13.3% of the time that brand's products are tried on. The chart also may set forth brand-to-brand data, namely, the percentage of sales by brand, as illustrated above.

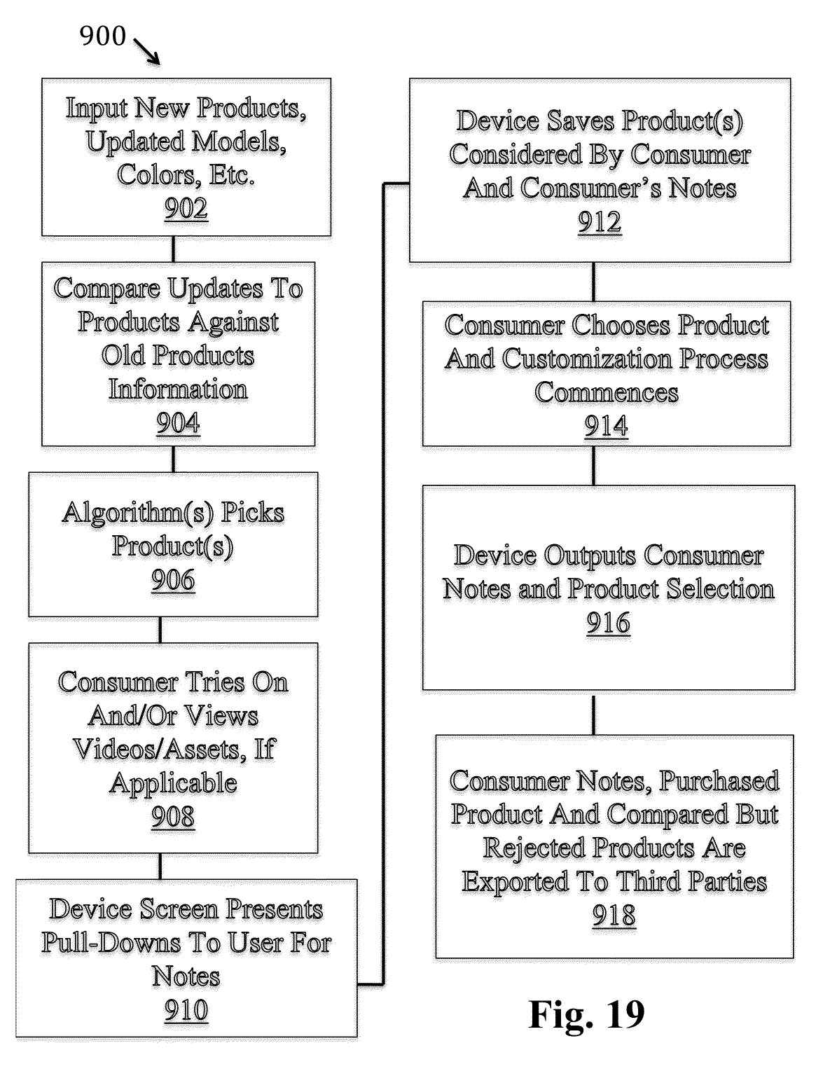

FIG. 19 is a flow diagram illustrating how the disclosed invention also advantageously may offer “personalized smart product recommendations.” Turning in detail to FIG. 19, the personalized smart product recommendations process 900 may begin with information pertinent to new products, updated models, color, etc. inputted into the application, as seen in block 902. Next, updates to products may be compared against old products by SKU or other manufacturing information, as per block 904. One or more algorithms then pick or make product recommendations, preferably by model number, SKU, or what is in inventory, as seen in block 906. Block 908 illustrates that the consumer may then try on and/or view video and/or photo assets pertinent to the products. The device screen then may be given to the consumer, via block 910, wherein the screen may present pull-downs to the consumer for notes and/or comments on the products tested and/or viewed. The products considered and/or viewed, along with any consumer notes, which are preferably tied into the individual consumer's records, are then saved in the device, per block 912. Once the consumer has chosen a product, as seen in block 914, the disclosed invention then advantageously permits that product to be customized and/or modified, as needed, with or without advice provided by the device, as discussed above particularly with regard to FIG. 5. Next, as seen in block 916, the device may optionally output, such as via printing or e-mail, consumer notes and/or product selection. The device may also optionally permit consumer notes, purchased product and compared but rejected products information to be exported to third parties, such as product manufacturers and retailers, as seen in block 918.

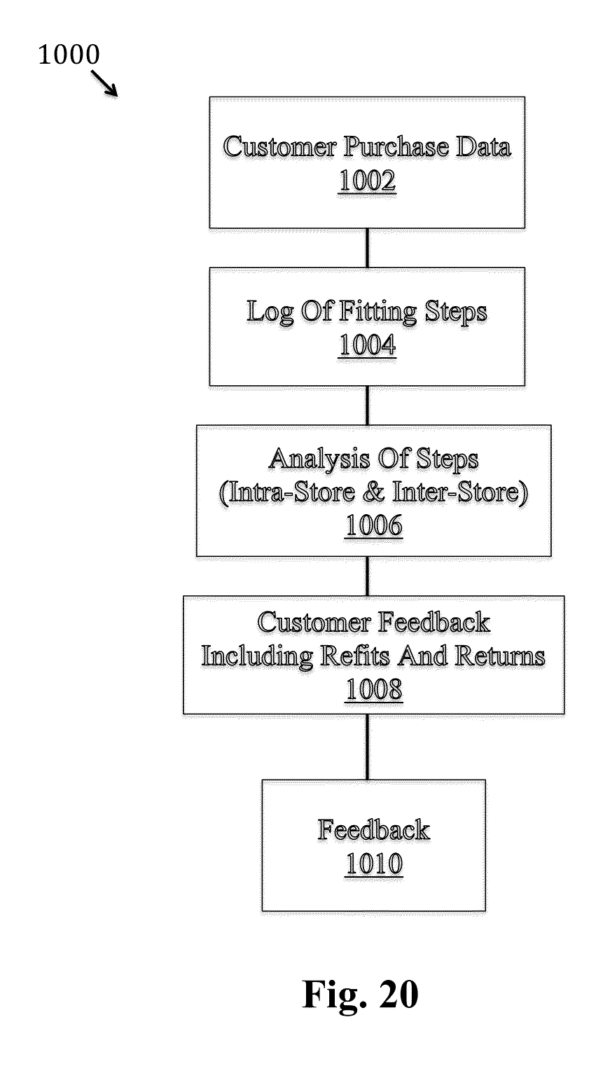

FIG. 20 is a flow diagram illustrating a codification process that creates a set of standards in industries where none essentially existed previously. An example of such an industry is the ski industry, such as the area of ski boots where designing and fitting a boot is more of an art than a science. Each ski boot designer may have their own unique way of doing things that may or may not be the most beneficial way to maintain customer satisfaction. A similar situation exists for fitting a boot. The codification process disclosed herein takes data gained from the fit process to provide invaluable feedback to third parties for myriad purposes, including setting empirically proven standards. For example, as the disclosed invention is advantageously capable of providing feedback data about sales, customer satisfaction, returns, and similar data points that can be related back to the fitting steps used in the sale of product, a person who custom fits ski boots is now for perhaps the first time able to see empirical data about which fitting steps are important and therefore understand which should be employed.

Turning in detail to FIG. 20, the codification process 1000 may use customer purchase data, per block 1002, such as data obtained from the disclosed strike rate process. This data may be combined with other data obtained from an analysis of fitting steps (intra-store and/or inter-store) logged during fitting, per blocks 1004 and 1006. For instance, such an analysis may show that if a “step 11—gait analysis” of a set of fitting steps is employed, running shoes sold have a customer satisfaction rate of 83%; however, if step 11 is not used, then customer satisfaction drops to 52%. This analytical data may also be combined with customer feedback data including refits and returns, per block 1008, to create feedback block 1010 and/or set of empirically proven standards.

While certain embodiments have been described, the embodiments have been presented by way of example only and are not intended to limit the scope of the inventions. Indeed, the novel devices and methods described herein may be embodied in a variety of other forms; furthermore, various omissions, substitutions, and changes in the form of the devices and methods described herein may be made without departing from the spirit of the inventions. The accompanying claims and their equivalents are intended to cover such forms or modifications as would fall within the scope and spirit of the inventions.

1. A method comprising:
obtaining data about a customer's physical characteristics and skill level in a sport;
obtaining product information about one or more products;
identifying one or more expert rules about product selection for the one or more products; and
applying the one or more expert rules to the customer data to select a product.

2. The method of claim 1, further comprising identifying one or more expert rules about product fit, and applying the one or more rules to the customer data to be able to advise how to custom fit the product.

3. The method of claim 1, further comprising encoding the steps of claim 1 on a computer readable medium operable to cause an electronic device to perform the operations comprising the steps of claim 1, and sending e-mail or text messages directly from the electronic device to a customer.

4. The method of claim 1, further comprising showing one or more manufacturer photos or video assets of the one or more products to a customer while the customer is trying on or comparing the one or more products.

5. An electronic device comprising:
one or more processors configured to perform operations comprising:
obtaining data about a customer's physical characteristics and skill level in an applicable sport;
obtaining product information about one or more products;
identifying one or more expert rules about product fit for the one or more products; and
applying the one or more expert rules to the customer data to be able to fit a product.

6. The device of claim 5, wherein the one or more processors are configured to perform operations further comprising identifying one or more expert rules about product selection, and applying the one or more rules to the customer data to be able to select a product.

7. The device of claim 5, wherein the one or more processors are configured to perform operations further comprising sending e-mail or text messages directly from the electronic device to a customer.

8. The device of claim 5, wherein the one or more processors are configured to perform operations further comprising showing one or more manufacturer photos or video assets of the one or more products to a customer while the customer is trying on or comparing the one or more products.

9. (canceled)

10. (canceled)

11. The device of claim 5, wherein the product is operable to cause the electronic device to perform operations further comprising showing one or more manufacturer photos or video assets of the one or more products to a customer while the customer is trying on or comparing the one or more products.

12. A system comprising:
one or more processors configured to perform operations comprising:
obtaining data about a customer's physical characteristics and skill level in an applicable sport;
obtaining product information about one or more products;
identifying one or more expert rules about product selection for the one or more products; and
applying the one or more expert rules to the customer data to select a product.

13. The system of claim 12, wherein the one or more processors are configured to perform operations further comprising identifying one or more expert rules about product fit, and applying the one or more rules to the customer data to be able to advise how to fit a product.

14. The system of claim 13, wherein the one or more processors are configured to perform operations further comprising sending e-mail or text messages directly from the electronic device to a customer.

15. The system of claim 13, wherein the one or more processors are configured to perform operations further comprising showing one or more manufacturer photos or video assets of the one or more products to a customer while the customer is trying on or comparing the one or more products.

16. The system of claim 12, wherein the one or more processors are configured to perform operations further comprising determining how often a specific item, a brand of item, or a category of item is chosen when it is actually considered for purchase.

17. The system of claim 12, wherein the one or more processors are configured to perform operations further comprising obtaining new manufacturer information about a product in inventory or previously sold to a customer to keep product recommendations current.

18. The system of claim 12, wherein the one or more processors are configured to perform operations further comprising obtaining feedback data involving one or more of the following steps: obtaining customer purchase data, obtaining a log of fitting steps used to fit a product and analyzing the fitting steps, and obtaining customer data about refits and returns.

19. The system of claim 18, wherein the log of fitting steps may be from one store internally or an inter-store log.
